(19) United States
(12) Patent Application Publication
(10) Pub. No.: US 2005/0164150 A1
(43) Pub. Date: Jul. 28, 2005

(54) Boxed set of prayer cards

(76) Inventor: Rosalind G. Woods, Los Angeles, CA (US)

Correspondence Address: Richard C. Litman, LITMAN LAW OFFICES, LTD., P.O. Box 15035, Arlington, VA, 22215, US

(21) Appl. No.: 10/762,288

(22) Filed: Jan. 23, 2004

(51) Int. Cl. G09B 19/00

(52) U.S. Cl. 434/245

(57) ABSTRACT

An assortment of cards, each card having a different prayer printed on one face thereof. A religious symbol or icon is inscribed on the other face of the card. Each prayer is worded to fill a specific need. The cards are color-coded to reflect the specific need. The cards are housed in a box, which box has a religious logo on the front face and the color-code index printed on the rear face.

### BACKGROUND OF THE INVENTION

1. Field of the Invention

The present invention generally relates to religious articles. More specifically, the present invention is drawn to a boxed set of prayer cards, which cards are color-coded to indicate specific areas of prayer.

2. Description of the Related Art

There are many instances when a supplicant seeks guidance from a higher power through prayer. Unfortunately, the problems and burdens of the world sometimes lay heavily and at such times the words one needs for prayer may not readily come. Even in times of joy, pure elation might cause one to be at a loss for the words needed to express gratitude for the received blessings. Although earnest prayer should be spontaneously spoken from the heart and soul, it would be helpful in such times of travail or joy if the petitioner had a means to suggest what specific prayer might be proper for the particular occasion. The art would certainly welcome uniquely constructed prayer cards for alleviating the above-stated problem.

Prayer cards are known in the related art. For example, the reference from the Online Store (www.homestead.com) features cards with personal prayers, Bible verses, etc. The advertisement does not contemplate fabricating prayer cards that are coded for specific needs.

Japanese Patent numbered 1-180395 discloses prayer cards imprinted with prayers and the name of a particular shrine indicating that the prayer was offered at the shrine.

U.S. Pat. No. Des. 333,614 (Miguel) is drawn to an ornamental design for a container for prayer cards. The patent does not suggest any particular form for the prayer cards.

U.S. Pat. No. 5,580,254 (Ramsey) shows a silent communication system involving color-coded cards. The colors represent different phrases.

U.S. Pat. No. 4,936,170 (Zumeta) discloses a color-coded system for classifying tools.

None of the above inventions and patents, taken either singly or in combination, is seen to disclose a color-coded prayer card system as will be subsequently described and claimed in the instant invention.

### SUMMARY OF THE INVENTION

The instant invention comprises an assortment of cards, each card having a different prayer printed on one face thereof. A religious symbol or icon is inscribed on the other face of the card. Each prayer is worded to fill a specific need. The cards are color-coded to reflect the specific need. As contemplated, the cards will be housed in a box, which box has a religious logo on the front face and the color code index printed on the rear face.

The objects of the present invention will become readily apparent upon further review of the following specification and drawings.

### BRIEF DESCRIPTION OF THE DRAWINGS

FIG. 1 is an environmental, perspective view of a prayer card according to the present invention.

FIG. 2 is a plan view of the front face of a prayer card according to the present invention.

FIG. 3 is a plan view of the rear face of a prayer card according to the present invention.

FIG. 4 is a front perspective view of a box to house a plurality of prayer cards according to the present invention.

FIG. 5 is a rear perspective view of a box to house a plurality of prayer cards according to the present invention.

Similar reference characters denote corresponding features consistently throughout the attached drawings.

### DETAILED DESCRIPTION OF THE PREFERRED EMBODIMENT

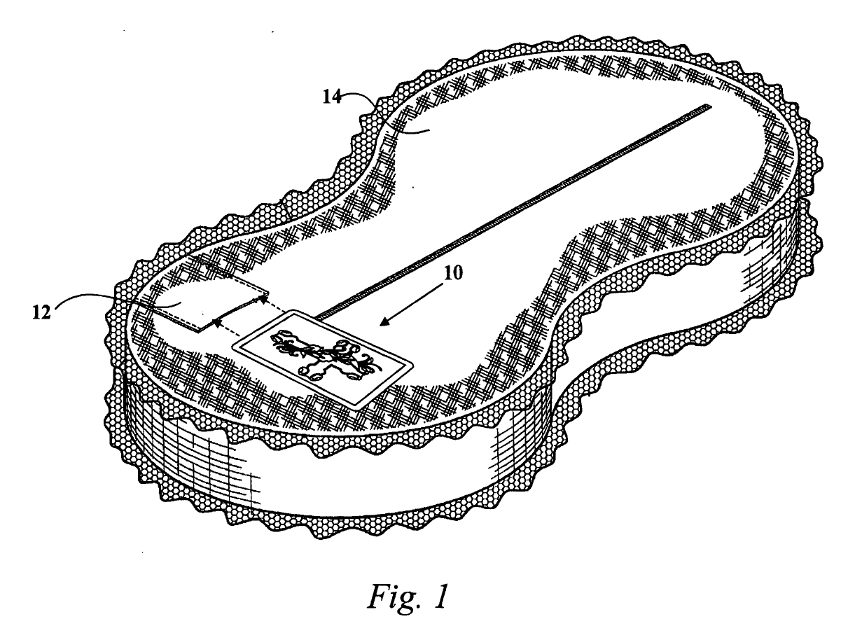

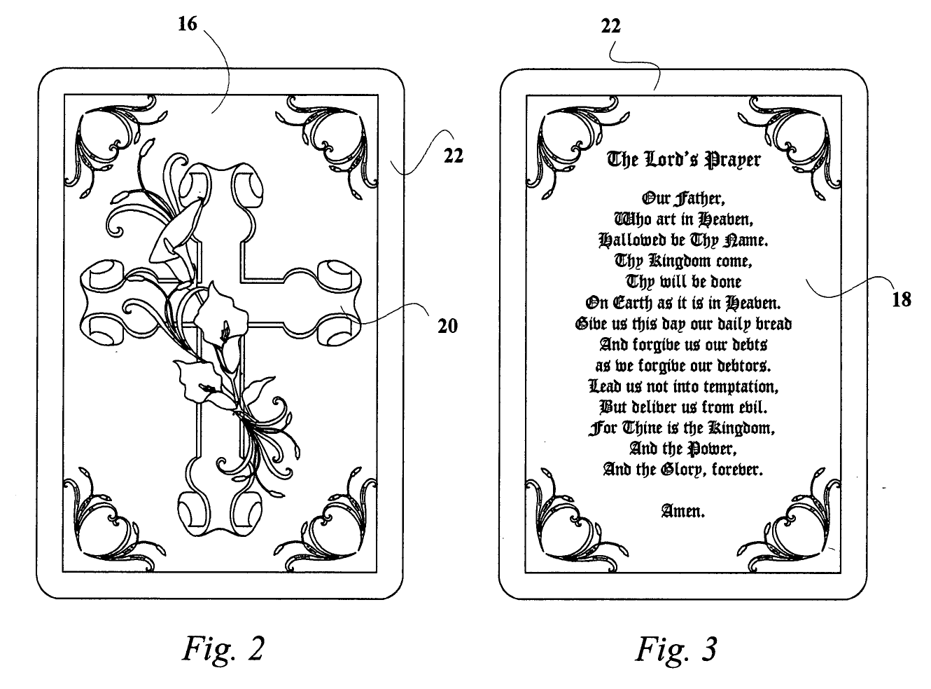

Attention is first directed to FIG. 1 wherein a prayer card of the present invention is generally indicated at 10. As illustrated, prayer card 10 or an assortment of such prayer cards that are needed for the day can easily be contained in the pocket 12 of a prayer cushion 14. As best seen in FIGS. 2 and 3, each prayer card comprises a planar member having a front face 16 and a rear face 18. The preferred card dimensions are four inches by 2 and one-half inches. It should be noted, however, that different dimensions may be successfully applied. A religious symbol or icon 20 is inscribed on the front face. The rear face is inscribed with a specific prayer. Each card will be provided with a distinct border 22. The border will be colored according to the type of prayer inscribed on the rear face. For example cards having a yellow border will be inscribed with prayers for protection; a pink border will indicate prayers for health; a green border will indicate prayers for prosperity; etc.

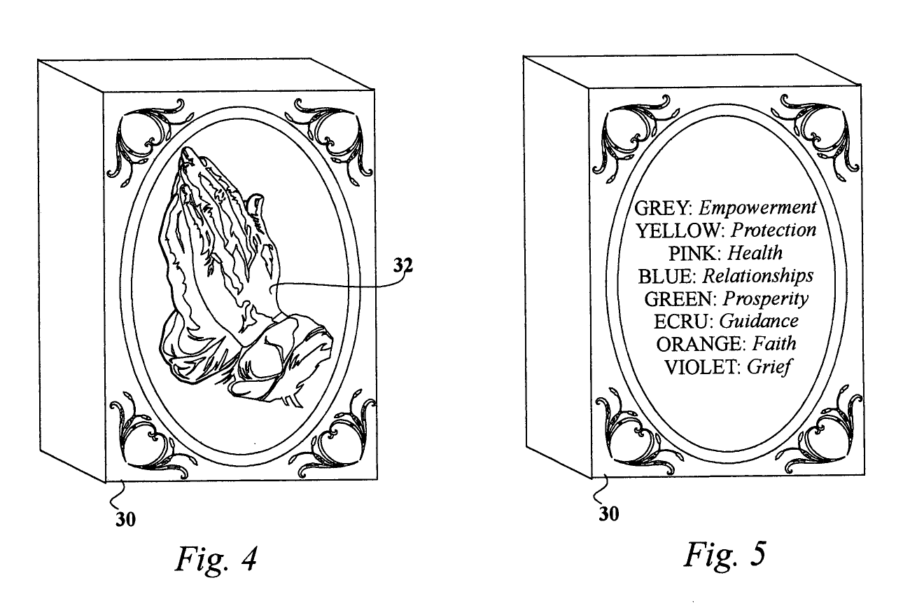

An assortment of cards 10 will be housed in a box 30 (FIGS. 4 and 5). The box has a front surface inscribed with a religious symbol 32. The rear surface of the box is inscribed with the color-coding index. As contemplated each box will contain a number of cards in several prayer categories. For example, a box of twenty-four cards might include six blue cards (relationships), six ecru cards (guidance), six orange cards (faith) and six violet cards (personal loss). The combination of specific prayer cards that may be housed in a box is endless. Each box will have one gold card, which card is inscribed with a specific universal prayer of a particular religion such as “The Lord's Prayer”. Blank cards in each color category will be available for writing personal prayers thereon.

It is to be understood that the present invention is not limited to the religious symbols illustrated in the embodiment described above, but encompasses symbols and prayers in any and all religious embodiments within the scope of the following claims.

1. An assortment of prayer cards, each card in said assortment comprising:
planar body member having a front face and a rear face, said planar body member having a peripheral border area therearound;
a religious symbol inscribed on said front face;
a prayer related to a specific category inscribed on said rear face; and
a specific color imprinted on said card, said color being coded to said specific category.

2. The assortment of prayer cards according to claim 1, wherein said specific color is imprinted in said border area.

3. The assortment of prayer cards according to claim 1, wherein said assortment includes plural sets of cards having different prayers of different specific categories imprinted thereon.

4. The assortment of prayer cards according to claim 1, including a box for housing said assortment of cards.

5. The assortment of prayer cards according to claim 1, wherein each card is approximately four inches by two and one-half inches.

6. An assortment of prayer cards, each card in said assortment comprising:
a planar body member having a front face and a rear face, said planar body member having a peripheral border area therearound;
a religious symbol inscribed on said front face;
a prayer related to a specific category inscribed on said rear face;
a specific color imprinted on said card, said color being coded to said specific category;
wherein said assortment includes plural sets of cards having different prayers of different specific categories imprinted thereon; and
a box for housing said plural sets of cards.

7. The assortment of prayer cards according to claim 6, wherein said specific color is imprinted in said border area.

8. The assortment of prayer cards according to claim 7, wherein said box has a front surface and a color-code index is inscribed on said front surface.

9. The assortment of prayer cards according to claim 7, wherein said box has a front surface and a color-code index is inscribed on said front surface.

10. The assortment of prayer cards according to claim 7, wherein each card is approximately four inches by two and one-half inches.

11. The assortment of prayer cards as recited in claim 7, wherein additional cards are provided that have no prayer inscribed thereon.
